(19) United States
(12) Patent Application Publication
(10) Pub. No.: US 2024/0215558 A1
(43) Pub. Date: Jul. 4, 2024

(54) FISHING TACKLE MANAGEMENT SYSTEM AND FISHING TACKLE MANAGEMENT PROGRAM

(71) Applicant: Shimano Inc., Osaka (JP)

(72) Inventors: Kento INOKUCHI, Osaka (JP); Takuya YASHIKI, Osaka (JP); Seishu MORI, Osaka (JP); Hitoshi HARAGUCHI, Osaka (JP); Shunsuke KUSANAGI, Osaka (JP); Kentaro HAYAsHI, Osaka (JP); Akira NIITSUMA, Osaka (JP); Mitsuyo MAEDA, Osaka (JP)

(21) Appl. No.: 18/367,303

(22) Filed: Sep. 12, 2023

(30) Foreign Application Priority Data
Dec. 28, 2022 (JP) 2022-211956

(51) Int. Cl. A01K 87/00; A01K 97/12

(52) U.S. Cl. CPC A01K 87/007; A01K 97/125

(57) ABSTRACT

A fishing tackle management system includes an identification unit for identifying fishing tackle from an image, a determination unit for making determinations regarding prescribed matters regarding to the fishing tackle based on the results of an identification of the identification unit, and a notification unit that controls user notifications of information based on the determination results of the determination unit.

### CROSS-REFERENCE TO RELATED APPLICATIONS

This application claims priority to Japanese Patent Application No. 2022-211956, filed on Dec. 28, 2022. The entire disclosure of Japanese Patent Application No. 2022-211956 are hereby incorporated by reference.

### BACKGROUND

### Technical Field

The present disclosure relates to a fishing tackle management system and a fishing tackle management program.

### Background Information

Some conventional technology can enable the management of the usage history of fishing tackle owned by a user with a mobile terminal, or the like. Such technology can use fishing tackle identification information obtained from RFID tags installed on fishing tackle, such as a fishing lures, fishing reels and fishing rods (for example, refer to Japanese Laid-Open Patent Application No. 2022-38637).

### SUMMARY

It has been determined that there is demand for simple management of fishing tackle owned by a user without the need to install RFID tags, for example.

In consideration of the problem described above, an object of the present disclosure is to provide a system and program to facilitate the management of fishing tackle.

A first aspect of the present disclosure that solves the above-mentioned problem is a fishing tackle management system comprising an identification unit for identifying fishing tackle from an image, a determination unit for making determinations regarding fishing tackle matters based on the identification results of the identification unit, and a notification unit that notifies to user based on the determination results of the determination unit as notifications of information.

According to the above-mentioned configuration, by the simple operation of taking an image of fishing tackle using a user terminal, for example, the user can be informed of the contents of determinations related to the inspection, etc., of the fishing tackle. Thus, fishing tackle can be easily managed.

A second aspect of the present disclosure is the fishing tackle management system of the first aspect, wherein the determination unit can make determinations regarding maintenance matters of the fishing tackle.

With the configuration described above, maintenance information of fishing tackle can be easily obtained.

A third aspect of the present disclosure is the fishing tackle management system of the second aspect, wherein the fishing tackle is a fishing reel, and wherein the determination unit can make determinations regarding reel maintenance matters of the fishing reel.

With the configuration described above, the user can easily obtain information regarding maintenance matters of the fishing tackle as a fishing reel.

A fourth aspect of the present disclosure is the fishing tackle management system of the third aspect, wherein the reel maintenance matters can include at least one of scratches on the fishing reel, distortion of parts of the fishing reel, fishing line issues of a fishing line wound on a spool, and reel setting state issues of the fishing reel.

With the configuration described above, it is possible to make determinations (inspections) regarding various maintenance matters of the fishing tackle as a fishing reel and to provide the user with the determination results.

A fifth aspect of the present disclosure is the fishing tackle management system of any one of the second to fourth aspects, wherein the determination unit can make determinations regarding rod maintenance matters of a fishing rod.

With the configuration described above, the user can easily obtain information regarding maintenance matters of the fishing tackle as a fishing rod.

A sixth aspect of the present disclosure is the fishing tackle management system of the fifth aspect, wherein the fishing rod maintenance-related matters can include at least one of scratches of the fishing rod, distortion of the fishing rod, and rod setting state issues of the fishing rod.

With the configuration described above, it is possible to make determinations (inspections) regarding various maintenance matters of the fishing tackle as a fishing rod and to provide the determination results to the user.

A seventh aspect of the present disclosure is the fishing tackle management system of the sixth aspect, wherein the rod setting state matters includes line guide issues or reel seat issues, the line guide issues including scratches or distortion of the line guide, and the reel seat issues including scratches or distortion of the reel seat.

With the configuration described above, it is possible to make determinations (inspections) regarding various maintenance matters of the fishing tackle as a fishing rod and to provide the determination results to the user.

An eighth aspect of the present disclosure is the fishing tackle management system of any one the first to the seventh aspects, wherein the identification unit can make for identification result from an operation sound of the fishing tackle, the determination unit is configured to obtain determination results by determining fishing tackle matters based on the identification results of the identification unit.

With the configuration described above, the user can be notified of the contents of determinations related to inspections, etc., of the fishing tackle not only with captured images, but also by a simple operation of recording the operation sound generated by the targeted fishing tackle using a user terminal, for example.

A ninth aspect of the present disclosure is the fishing tackle management system of any one of the first to the seventh aspects, wherein the determination unit can make determinations regarding maintenance matters related to performance of maintenance work of the fishing tackle.

With the configuration described above, the user can be provided with information regarding maintenance matters related to performance of maintenance work of the fishing tackle.

A tenth aspect of the present disclosure is the fishing tackle management system of the ninth aspect, wherein the notification unit can also make notifications of information regarding cost information based on maintenance matters determined by the determination unit to user.

With the configuration described above, the user can be notified of required maintenance-related costs.

An eleventh aspect of the present disclosure is a fishing tackle management program for causing a computer to function as the fishing tackle management system according to any one of the first through tenth aspects.

With the fishing tackle management system and a fishing tackle management program of the present disclosure, it is possible to realize the effect of facilitating the management of fishing tackle.

### BRIEF DESCRIPTION OF THE DRAWINGS

FIG. 1 is an example of the overall configuration of the fishing-related information processing system according to a first embodiment.

FIG. 2 is an example of the external appearance of the fishing reel as an electric reel according to the first embodiment.

FIG. 3 is an example of the external appearance of the fishing reel as an electric reel according to the first embodiment.

FIG. 4 is a diagram showing an example of the functional configuration of the fishing reel as an electric reel according to the first embodiment.

FIG. 5 is a diagram showing an example of the functional configuration of a user terminal in the first embodiment.

FIG. 6 is a diagram showing an example of the functional configuration of a maintenance support server according to the first embodiment.

FIG. 7 is a flowchart showing an example of the processing procedure executed by the maintenance support server and the user terminal of the first embodiment in relation to the inspection of the fishing tackle.

FIG. 8 is a flowchart showing an example of the processing procedure executed by the maintenance support server and the user terminal of the second embodiment in relation to the inspection of the fishing tackle.

### DETAILED DESCRIPTION OF EMBODIMENTS

### First Embodiment

### Example of the Configuration of the Fishing Tackle Maintenance Support System

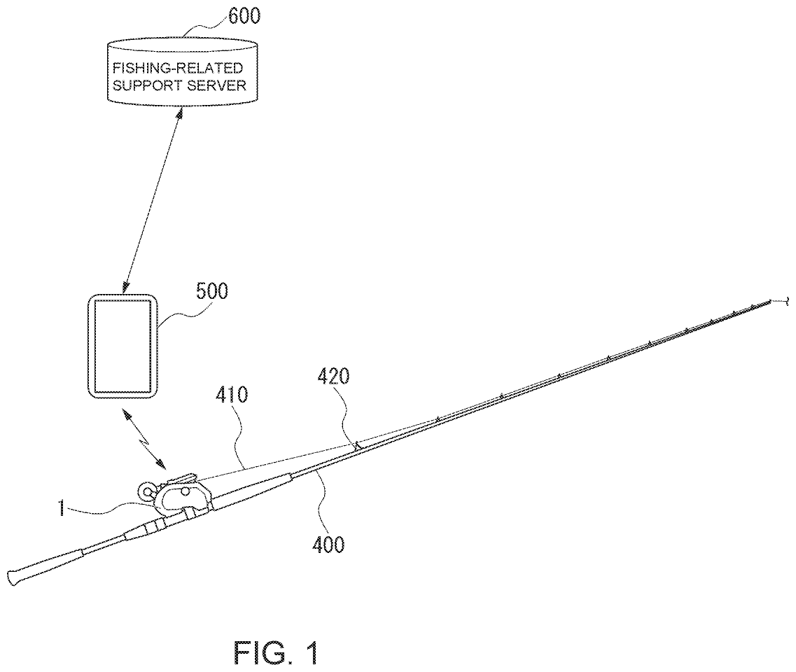

FIG. 1 shows an example of the overall configuration of a fishing tackle maintenance support system (one example of a fishing tackle management system) according to the present embodiment. The fishing tackle maintenance support system of the present embodiment supports the maintenance of fishing tackle by the user. In this Specification, “the maintenance of fishing tackle” includes at least inspection of fishing tackle, overhaul of fishing tackle, repair of fishing tackle, etc. For example, in the case of a fishing reel, overhaul includes work such as disassembly, etc., of the fishing reel for cleaning and replacement of deteriorated parts. The repair of fishing tackle includes the repair of scratched and distorted parts and components, the replacement of deteriorated or damaged parts, etc.

The fishing tackle maintenance support system shown in FIG. 1 is equipped with a fishing reel 1, a fishing rod 400 (one example of a fishing rod), a user terminal 500, and a maintenance support server 600.

In use, the fishing reel 1 is mounted on the fishing rod 400. A fishing line 410 drawn out from the spool of the fishing reel 1 is passed through a plurality of fishing line guides 420. A lure (not shown) is tied to the fishing line 410 drawn through the fishing line guide 420 at the end of the rod.

The user terminal 500 is used by an angler (i.e. a user). The user terminal 500 can be, for example, a smartphone, a tablet terminal, or the like. The user terminal 500 of the present embodiment has a camera, and therefore has an image capturing function for obtaining still or moving images through image capture.

The user terminal 500 of the present embodiment can also have an installed maintenance support application to support maintenance of the fishing tackle.

The fishing reel 1 is communicatively connected to the user terminal 500. Communication between the user terminal 500 and the fishing reel 1 can be wireless or wired, but wireless communication will be described below as an example. Further, the wireless communication method between the user terminal 500 and the fishing reel 1 is not particularly limited and can be short-range wireless communication, such as BLE (Bluetooth Low Energy), NFC (Near Field Communication), etc.

The maintenance support server 600 is communicatively connected to the user terminal 500 via a network. The maintenance support server 600 provides user-oriented maintenance information of fishing tackle, as described further below. The provision of information can be realized by transmitting the information from the maintenance support server 600 to the user terminal 500, and outputting the transmitted information from the user terminal 500 as sound or visually on a display.

### Example of a Structure of the Fishing Reel

In the present embodiment, the case in which the fishing reel 1 is an electric reel is used as an example.

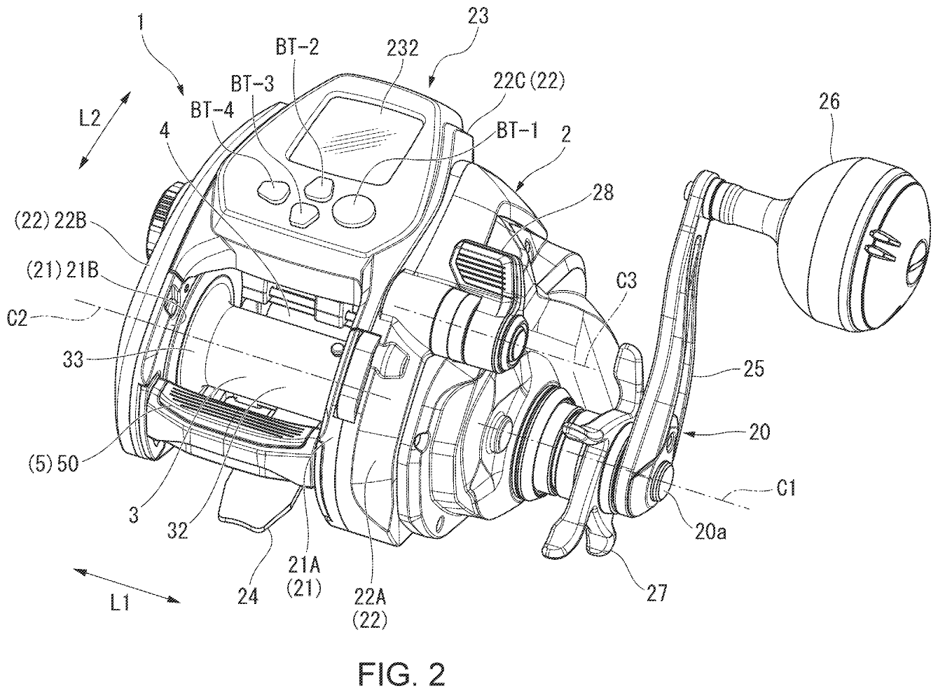

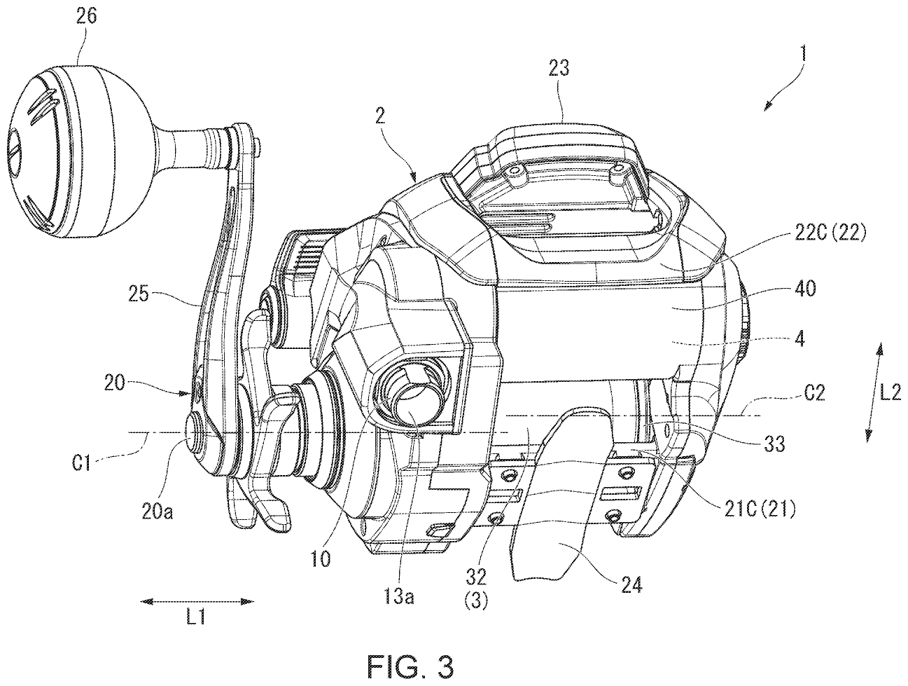

FIGS. 2 and 3 show an example of the external appearance of the fishing reel 1 as an electric reel. The fishing reel 1 shown in FIGS. 2 and 3 is driven by the electric power supplied from an external power source and also has an internal power source for use as a hand-wound dual-bearing reel.

The fishing reel 1 comprises a reel body 2 that can be mounted on the fishing rod, a handle 20 that is attached to the reel body 2 so as to be rotatable about a handle axis C1, a spool 3 rotatable about a spool axis C2 that is parallel to handle axis C1 with respect to the reel body 2 and around which a fishing line, not shown, is wound, and a motor 4 disposed in the reel body 2 that transmits a rotational drive force to the spool 3.

The fishing reel 1 also has a clutch mechanism 5. The clutch mechanism 5 is a mechanical part configured to be able to switch between a connected (clutch-on) state in which the spool 3 and the handle 20 are connected and a disconnected (clutch-off) state in which the spool 3 and the handle 20 are disconnected. The clutch can be switched between the clutch-on state and the clutch-off state by operation of a clutch operating member 50 by an angler as the user.

Here, in the present embodiment, the handle axis C1 and the spool axis C2 are parallel, in the direction necessarily defined as the left-right direction L1; the direction that is orthogonal to the left-right direction L1 and in which the fishing line is wound around the spool 3 and is paid out (i.e., cast) is defined as the front-rear direction L2. Further, the direction in which the fishing line is paid out from the spool 3 in the front-rear direction L2 is defined as the front, the opposite direction is defined as the rear, and left and right are defined in relation to the fishing reel 1 as seen from the rear.

FIG. 2 is a perspective view of the fishing reel 1 as seen obliquely from above and the rear, and FIG. 3 is a perspective view of the fishing reel 1 as seen obliquely from below and the front.

The reel body 2 comprises a body frame 21, a cover 22 that covers a portion of the body frame 21, and a display operation panel part 23 positioned above the body frame 21.

The body frame 21 is an integrally formed member made of synthetic resin or metal, for example. Sandwiching the spool 3 in the left-right direction L1, the body frame 21 has a right-side plate 21A on the handle 20 side and a left-side plate 21B opposite the right-side plate 21A, and a plurality of connecting members 21C that connect the right-side plate 21A and the left-side plate 21B.

The right-side plate 21A and the left-side plate 21B are separated from each other in the left-right direction L1. Further, support portions that support the spool 3 and the motor 4, and a rotary drive mechanism such as the clutch mechanism 5, are disposed on each of the side plates 21A, 21B.

The ends of a rotary shaft (not shown) of the spool 3 are supported and attached to the right-side plate 21A and the left-side plate 21B so as to be freely rotatable. The connecting member 21C shown in FIG. 3 is plate-shaped and connects the lower portions of the right-side plate 21A and the left-side plate 21B. One of the connecting members 21C is fitted with a fishing rod mounting portion 24 for attachment to the fishing rod at approximately the central portion in the left-right direction L1.

The cover 22 includes a right-side cover 22A, a left-side cover 22B, and a front cover 22C. The right-side cover 22A covers the right-side plate 21A with a prescribed housing space therebetween and is, for example, screwed onto the outer edge of the right-side plate 21A. The left-side cover 22B covers the left-side plate 21B with a prescribed housing space therebetween and is, for example, screwed onto the outer edge of the left-side plate 21B. The front cover 22C covers the front portion of the body frame 21.

Further, although not shown, a connector for connecting a power supply cable from the outside is disposed on the lower front portion of the right-side plate 21A.

The display operation panel part 23 is directed toward the angler that uses the fishing reel 1 and is the part operated by the angler (button operation in this embodiment).

The display operation panel part 23 is located between the right-side plate 21A and the left-side plate 21B. The display operation panel part 23 has a button section 231 and a display surface section 232.

The button section 231 is the section where button operations are performed by the angler. In the example shown in the figure, four buttons (operators) are arranged in the button section 231: a first button BT-1, a second button BT-2, a third button BT-3, and BT-4.

In the following description, when no specific distinction is to be made, the first button BT-1, the second button BT-2, and the third button BT-3 will be referred to as button BT.

The first button BT-1 is used in an operation in which the spool 3 is electrically rotated at a preset speed pattern.

Specifically, the first button BT-1 is normally used for a temporary motor winding operation. Temporary motor winding is an operation for driving the motor 4 so that the spool 3 rotates at a preset constant speed as a speed pattern when the first button BT-1 is pressed. The rotational speed of the spool 3 during temporary motor winding can be changed by angler operation.

Further, the first button BT-1 is operated to instruct the execution of a jigging function in jigging mode. The jigging function is used to rotate the spool 3 with a preset jigging pattern as the speed pattern in response to a single pressing operation of the first button BT-1. The jigging pattern is set, for example, to achieve an operation in which the spool 3 is rotated to wind the fishing line at a prescribed speed for a set period of time, and then the rotation of the spool 3 is stopped for a set period of time.

The display surface section 232 is a part where prescribed contents are displayed in accordance with an operation of the fishing reel 1. The display device disposed at the display surface section 232 is not particularly limited, but can include, for example, a liquid-crystal display device, an organic EL display device, and the like.

As shown in FIGS. 2 and 3, the handle 20 has a handle arm 25 that is non-rotatably fixed to the distal end portion 20a of the handle shaft, a handle knob 26 that is mounted on one end of the handle arm 25 freely rotatable about an axis parallel to the handle axis C1, and a drag 27 disposed on the reel body 2 side.

The torque from the handle 20 is directly transmitted to the spool 3 when the clutch mechanism 5 is in the clutch-on state.

The spool 3 is freely rotatable between the right-side plate 21A and the left-side plate 21B by shaft bearings (not shown). The spool 3 includes a rotary shaft, not shown, a cylindrical bobbin trunk 32 that is disposed coaxially with the spool rotary shaft and that can rotate in conjunction therewith, and a flange portion 33 on each end of the bobbin trunk 32 whose diameter expands radially outwardly.

The spool 3 is rotationally driven by the motor 4 via a spool drive mechanism, not shown, and is interlocked with the clutch mechanism 5 that is driven by the clutch operating member 50. The spool rotary shaft is supported by the right-side cover 22A and the left-side cover 22B via shaft bearings, so as to be freely rotatable.

The clutch mechanism 5 can be switched between the clutch-on state, in which the rotation of the handle 20 can be transmitted to the spool 3, and the clutch-off state, in which the rotation of the handle 20 cannot be transmitted to the spool 3, by operation of the clutch operating member 50. In the clutch-on position, the rotation of a pinion gear is transmitted to the spool rotary shaft, resulting in the clutch-on state, and the pinion gear and the spool rotary shaft can integrally rotate. In the clutch-off position, the rotation of the pinion gear is not transmitted to the spool rotary shaft, resulting in the clutch-off state, and the spool 3 rotates freely.

As shown in FIG. 2, the clutch operating member 50 is a part for performing an operation to switch the clutch mechanism 5 between the clutch-on state and the clutch-off state.

The clutch operating member 50 is disposed at the rear of the reel body 2, between the right-side plate 21A and the left-side plate 21B, movable toward and away from the rear of the reel body 2 with respect to the fishing rod mounting portion 24. In the present embodiment, the clutch operating member 50 is provided so as to be pivotable about the spool rotary shaft.

The spool drive mechanism drives the spool 3 to rotate in the line winding (take-up) direction. Further, a drag force is generated against the spool 3 by the drag 27 during winding, thereby preventing fishing line breakage.

The drag 27 is coaxially installed on the handle shaft between the right-side cover 22A and the handle arm 25 of the handle 20. The spool drive mechanism includes the above-described motor 4, whose rotation in the winding direction is prohibited by an anti-reverse mechanism in the form of a roller clutch, not shown, and a rotation transmission mechanism that decelerates and transmits the rotation of the motor 4 to the spool 3 or accelerates and transmits the rotation of the handle 20 to the spool 3.

As shown in FIG. 3, the motor 4 is located at the front portion of the fishing reel 1A, in a more forward position than the spool 3 (see FIG. 2) in the front portion, and is covered by a half-split-shaped motor housing body 40.

A spool drive lever 28 is configured to be rotatable about a rotational axis C3 within a certain range of rotation in accordance with user operation. The spool drive lever 28 is an actuator with which an operation is performed to drive the spool 3 in the direction of rotation corresponding to the direction in which the fishing line is wound (take-up direction). The spool drive lever 28 is configured to change the rotational speed of the spool 3 in accordance with its rotational position. For example, if the spool drive lever 28 is rotated to the rearmost position (the frontmost position from the point of view of the user who performs the operation), the spool 3 is stopped, and as the lever is rotated forward from this position, the rotational speed of the spool is made to increase in a stepwise manner. The rotational speed of the spool 3 can be configured to increase linearly, rather than in a stepwise manner, as the spool drive lever 28 is rotated forward. In the following description, the embodiment in which the speed is changed in a stepwise manner will be described as an example.

### Overview of Maintenance Support

In the fishing tackle maintenance support system of the present embodiment, the inspection of the fishing tackle is performed as maintenance.

When the fishing tackle is inspected, the user operates the user terminal 500 that runs the maintenance support application to capture an image of the fishing tackle to be inspected so that the part corresponding to the matter for inspection is included in the image capture range.

When the image capture operation is performed in this way, the user terminal 500 acquires an image (captured image) that includes the fishing line wound around on the spool. The captured image can be a moving image or a still image.

In response to the user taking an image of the portion corresponding to the matter for inspection, the user terminal 500 transmits an inspection request that contains the captured image to the maintenance support server 600. The maintenance support server 600 performs an inspection (determination) using the captured image included in the inspection request and transmits an inspection result (determination result) to the user terminal 500.

The user terminal 500 notifies the user of the received inspection result. Notification of the inspection result can be carried out audibly or visually on a display, or both audibly and visually.

In the present embodiment, the fishing tackle to be inspected, and the inspection-related matters, etc., regarding the fishing tackle to be inspected are not particularly limited. Specifically, examples of fishing tackle to be inspected include fishing reels, fishing rods, and tackle (including lures, etc.).

Further, examples of inspection-related matters when the fishing tackle to be inspected is a fishing reel (one example of a reel maintenance-related matter) include scratches of the fishing reel (for example, the presence or absence of scratches that hinder use), distortion of parts of the fishing reel (for example, distortion of the spool shaft or handle), the condition of fishing line that is inspection around the spool (for example, deterioration of the fishing line, the length of fishing line wound around the spool, the shape of the wound fishing line (uneven winding of the fishing line due to abnormal oscillation mechanism or level winding mechanism), etc.), and reel setting states issues of the fishing reel.

Further, examples of inspection-related matters when the fishing tackle to be inspected is a fishing rod (one example of a fishing rod maintenance-related matter) include scratches of the fishing rod body (for example, the presence or absence of scratches that hinder use), distortion of the fishing rod body (for example, the presence or absence of warping caused by the storage conditions of the fishing rod), rod setting state issues of the fishing rod, etc. Examples of matters regarding parts include line guides issues (for example, scratches, warping, etc., of the fishing line guide), reel seat issues of the reel seat (for example, scratches, warping, etc., of the reel seat), and the like.

In the following description, for the sake of clarity of explanation, the case in which the inspection target is the deterioration of fishing line wound around a spool will be described as an example.

In this case, in accordance with the inspection of the deterioration of the fishing line, the user operates the user terminal 500 to capture an image such that the fishing line wound around the spool of the fishing reel is within the image capture range. By this image capture operation, the user terminal 500 acquires an image (captured image) that includes the fishing line wound around the spool. The user terminal 500 transmits an inspection request including the acquired captured image to the maintenance support server 600.

The maintenance support server 600 uses the captured image included in the received inspection request to make a determination regarding the deterioration of the fishing line.

For example, if the fishing line is a PE line, the fishing line will fray during actual fishing. The maintenance support server 600 can determine the state of fraying of the fishing line identified from the captured image, thereby determining the degree of deterioration of the fishing line in accordance with the extent of fraying, for example. The maintenance support server 600 is also configured to be capable of determining whether the fishing line wound around the spool should be replaced (one example of a maintenance performance-related matter) by assessing whether the degree of deterioration exceeds a certain level.

In this case, the user terminal 500 issues a notification of the deterioration of the fishing line as the inspection result. A notification regarding the deterioration of the fishing line can include content that reports the degree of deterioration at a prescribed stage. Further, the notification regarding the deterioration of the fishing line can include content advising whether or not it is necessary to replace the fishing line.

Further, regarding the inspection of the deterioration of the fishing line, if it is determined that the fishing line should be replaced, the maintenance support server 600 can provide information regarding recommended fishing line products. In this case, the provided product information can include, for example, the price of the fishing line (i.e., the cost associated with the purchase of the fishing line).

Further, when the above-mentioned inspection of the fishing reel for fishing line deterioration, or the like is performed, the maintenance support server 600 can also use reel usage history information, which indicates the history of use of the fishing reel.

The usage history information of the fishing reel can be managed by the fishing reel. The fishing reel acquires information indicating how the fishing reel was used based on outputs of various sensors disposed on the fishing reel and the history of operation, etc., and stores the acquired information as the reel usage history information.

The reel usage history information can include, for example, the history of new fishing line wound around the spool, the number of times that a lure has been thrown (cast), the history of rotation of the spool for each cast of a lure, the history of user operations regarding the rotation of the spool for each cast of a lure, changes in tension on the fishing line measured for each cast of a lure, the length of fishing line thus far wound up, etc.

When transmitting an inspection request, the user terminal 500 acquires the reel usage history information from the fishing reel to be inspected via communication. The user terminal 500 transmits an inspection request, which includes the reel usage history information as well as the captured image, to the maintenance support server 600.

The maintenance support server 600 uses the captured image and the reel usage history information included in the received inspection request to make a determination regarding the inspection.

In this case, the maintenance support server 600 can use the reel usage history information in addition to the captured image to increase the accuracy of the inspection result.

Taking the case of determining the deterioration of the fishing line as an example, the maintenance support server 600 integrates the degree of deterioration of the fishing line determined based on the captured image and the history of usage of the fishing line obtained from the reel usage history information to determine the state of deterioration of the fishing line. In this case, it can be expected that the accuracy of the determination will be higher than that for the case in which the state of deterioration of the fishing line is determined based on the captured image without referring to the reel usage history.

### Example of the Functional Configuration of the Fishing Reel

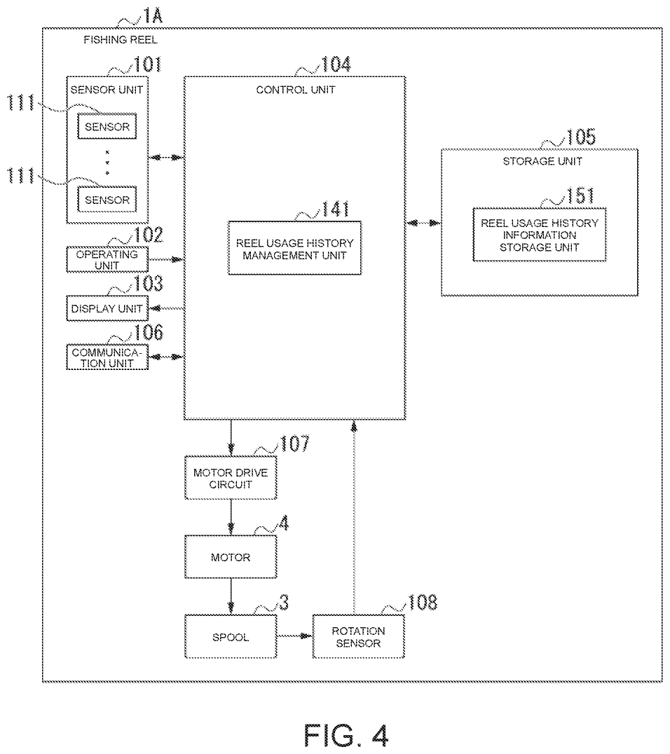

An example of the functional configuration of the fishing reel 1 as an electric reel will be described with reference to FIG. 4. In FIG. 4, the same parts as those in FIGS. 2 and 3 have been assigned the same reference symbols and descriptions thereof are omitted.

The fishing reel 1 illustrated in FIG. 4 comprises a sensor unit 101, an operating unit 102, a display unit (display) 103, a control unit (controller) 104, the storage unit 105, a communication unit 106, a motor drive circuit 107, the motor 4, the spool 3, and a rotation sensor 108.

The sensor unit 101 includes one or more prescribed sensors 111 disposed on the fishing reel 1. The sensors 111 can include a sensor for detecting the movement of the fishing reel 1 itself, a sensor for detecting vibrations of the fishing reel 1, and the like. For example, angular velocity sensors, piezoelectric sensors, and the like, can be used as the sensors 111 that detect movement and vibrations of the fishing reel 1 in this manner.

The operating unit 102 includes parts of the fishing reel 1 that are operated by the user, such as buttons, handles, levers, etc. In correspondence to FIG. 2, the operating unit 102 includes the button section 231.

The display unit 103 is the part that displays in accordance with the control of the control unit 104. In correspondence with FIG. 2, the display unit 103 includes the display surface section 232.

The control unit 104 executes various controls in the fishing reel 1. The functions as the control unit 104 are realized by a CPU (Central Processing Unit) disposed in the fishing reel 1 that executes a program. The control unit 104 includes a reel usage history information management unit 141.

The reel usage history information management unit 141 manages reel usage history information. The reel usage history information management unit 141 uses information detected by a prescribed sensor 111, information regarding the rotation of the spool 3 obtained by the rotation sensor 108, etc., to generate the reel usage history information and causes a reel usage history information storage unit 151 to store the generated reel usage history information.

The reel usage history information management unit 141 can obtain, for example, reel usage history information indicating that new fishing line has been wound onto the spool based on whether an operation corresponding to having new fishing line wound onto the spool has been performed.

Further, the number of times that a lure has been thrown (cast) can be obtained by counting the number of times that the spool 3, in a freely rotatable state with the clutch mechanism turned off, has rotated a prescribed number of times or more in the fishing line pay-out direction (a prescribed length or more of the fishing line is paid out).

Further, the history of the rotation of the spool each time a lure is cast can be obtained based on information regarding the rotation of the spool 3 detected by the rotation sensor 108, operations to activate the motor 4 to rotate in the take-up direction of the spool 3, etc., during the period between the time casting of the lure is started until the time that the lure is retrieved, for example.

Changes in the tension on the fishing line each time a lure is cast can be obtained by measurement, based on changes in the rotational speed of the spool 3 detected by the rotation sensor 108, for example.

The history of line breaks near the end of the rod can be obtained based on a history of prescribed operations corresponding to line breaks that occur near the end of the rod, such as resetting the water depth in response to line breaks.

The storage unit 105 stores various types of information regarding the fishing reel 1. The storage unit 105 includes the reel usage history information storage unit 151.

The reel usage history information storage unit 151 stores reel usage history information.

The communication unit 106 supports short-range wireless communication, for example, and is communicatively connected to the user terminal 500.

The motor drive circuit 107 drives the motor 4 in accordance with the control by the control unit 104. The control unit 104 changes the duty ratio of the pulse width of the motor drive signal by PWM (Pulse Width Modulation) control, thereby changing the rotation speed of the motor 4.

The rotation sensor 108 detects the number of revolutions of the spool (number of rotations), the rotation speed of the spool 3, etc.

### Example of the Functional Configuration of the User Terminal

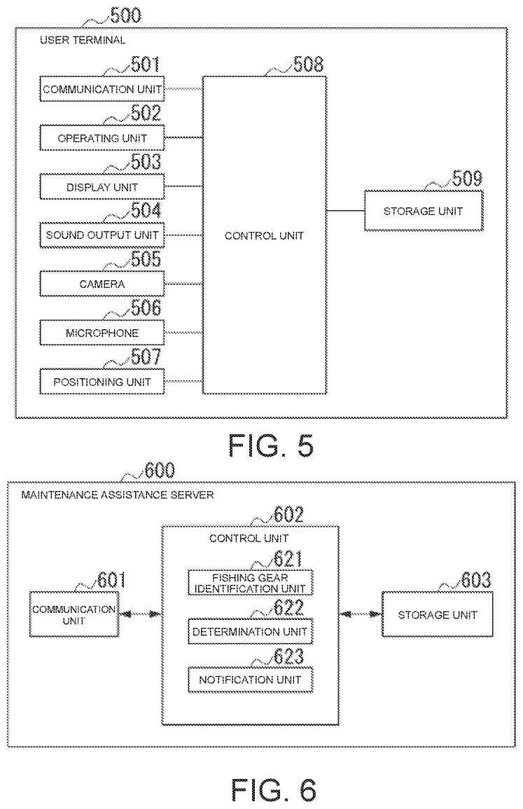

An example of the functional configuration of the user terminal 500 will be described, with reference to FIG. 5. The user terminal 500 of the figure comprises a communication unit 501, an operating unit 502, a display unit (display) 503, a sound output unit 504, a camera 505, a microphone 506, a positioning unit 507, a control unit (controller) 508, and a storage unit 509.

The communication unit 501 is a part corresponding to the communication function possessed by the user terminal 500. Specifically, the communication unit 501 supports short-range wireless communication and is connected to the fishing reel 1, or the like within a communication range for communication. Further, the communication unit 501 supports network communication and connects to other terminals, servers, and other nodes via a network.

The operating unit 502 is a part that encompasses actuators and input devices disposed in the user terminal 500, or input devices connected to the user terminal 500.

The display unit 503 displays in accordance with the control by the control unit 508.

A touch panel with which it is possible to perform operations on a display surface on which images are displayed in the user terminal 500 can be provided as the operating unit 502 and the display unit 503.

The sound output unit 504 outputs sound in accordance with the control by the control unit 508.

The camera 505 outputs captured images obtained by image capture.

The control unit 508 executes various controls in the user terminal 500. The functions as the control unit 104 are realized by the CPU provided in the user terminal 500 executing a program.

The storage unit 509 stores various types of information regarding the user terminal 500.

The positioning unit 507 measures the location of the user terminal 500 in accordance with a GPS (Global Positioning System), or the like, and outputs position information indicating the measured location.

### Example of the Functional Configuration of the Maintenance Support Server

An example of the functional configuration of the maintenance support server 600 will be described with reference to FIG. 6. The maintenance support server 600 shown in FIG. 6 comprises a communication unit 601, a control unit (controller) 602, and a storage unit 603.

The communication unit 601 is communicatively connected to the user terminal 500 via a network.

The control unit 602 executes various controls in the maintenance support server 600. The control unit 602 includes an identification unit 621, a determination unit 622, and a notification unit 623.

The identification unit 621 identifies fishing tackle from a captured image transmitted from the user terminal 500. The identification unit 621 can use a learned model that has been trained to identify types of fishing tackle in accordance with captured images input for the purpose of identifying the fishing tackle.

The determination unit 622 makes determinations regarding maintenance-related matters regarding the identified fishing tackle based on the identification result of the fishing tackle by the identification unit 621. That is, the determination unit 622 performs an inspection of the identified fishing tackle.

Specifically, when the identification unit 621 identifies the fishing line wound around the spool 3 from a captured image, the determination unit 622 makes a determination regarding the deterioration of the fishing line as the condition of the identified fishing line. In this case, as described above, the determination unit 622 can refer to the reel usage history information in addition to the captured image included in the inspection request transmitted from the user terminal 500.

When making a determination regarding maintenance-related matters regarding fishing tackle, the determination unit 622 can use a learned model that has been trained to output determination results regarding the corresponding maintenance-related matter in accordance with an input image of the fishing tackle (and the reel usage history information).

The determination unit 622 can also make determinations regarding matters that are not necessarily considered maintenance-related matters, such as the manufacturer and product number of the identified fishing tackle as a product.

The notification unit 623 executes control such that the user is notified of maintenance-related information based on the determination result (inspection result) of the determination unit 622. Specifically, for example, the notification unit 623 generates a web page of a maintenance screen that reflects the determination result of the determination unit 62 and transmits the generated web page to the accessing user terminal 500. By displaying such a web page on the user terminal 500, maintenance-related information can be reported to the user. Further, if the maintenance-related information can be played back by voice on the maintenance screen web page, notification of the maintenance-related information is performed by voice.

### Example Processing Procedure

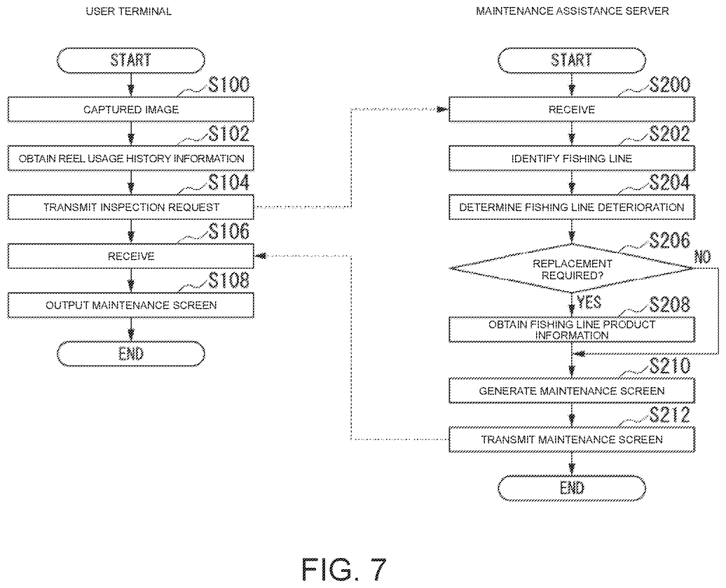

An example of the processing procedure performed by the maintenance support server 600 and the user terminal 500 of the present embodiment in relation to the inspection of fishing tackle will be described with reference to the flowchart of FIG. 7. In the description of FIG. 7, the case of inspecting (determining) the deterioration of the fishing line wound on the spool 3 will be described as an example of the inspection of fishing tackle.

An example of the processing procedure performed by the user terminal 500 will be described first.

Step S100: When the deterioration of the fishing line wound on the spool 3 is to be inspected, the user operates the user terminal 500 to cause the camera 505 to capture an image of the spool 3 on which the fishing line is wound. The control unit 508 of the user terminal 500 acquires the captured image obtained by the camera 505 by image capture.

Step S102: The control unit 508 causes the communication unit 501 to be communicatively connected to the fishing reel 1. The control unit 508 acquires the reel usage history information stored by the communicatively connected fishing reel 1.

Step S104: The control unit 508 causes the maintenance support server 600 to access the user terminal 500 via a network. The control unit 508 transmits, to the maintenance assistance server 600 via a network, an inspection request that includes the captured image acquired in Step S100 and the reel usage history information acquired in Step S102 and that issues an instruction to inspect the fishing line for deterioration.

Step S106: The control unit 508 receives a maintenance screen transmitted from the maintenance support server 600 in response to the inspection request transmitted in Step S104.

Step S108: The control unit 508 causes the display unit 503 to output the maintenance screen received in Step S106. Further, if voice is added to the maintenance screen, the control unit 508 can output the added voice to the sound output unit 504.

An example of the processing procedure performed by the maintenance support server 600 will now be described.

Step S200: In the maintenance support server 600, the identification unit 621 receives the inspection request transmitted from the user terminal 500 in Step S104.

Step S202: The identification unit 621 identifies the fishing line wound on the spool 3 from the captured image included in the inspection request received in Step S200.

Step S204: The determination unit 622 makes a determination regarding to the deterioration of the fishing line identified in Step S202. As described above, the determination unit 622 can determine, as the deterioration of the fishing line, the extent of deterioration of the fishing line and whether a replacement commensurate with the extent of deterioration is required.

Step S206: In this case, the determination unit 622 determines whether a determination result indicating that it is necessary to replace the fishing line was obtained in the determination regarding the deterioration of the fishing line in Step S204.

Step S208: If a determination result indicating that it is necessary to replace the fishing line is obtained, the notification unit 623 acquires product information (fishing line product information) regarding the fishing line recommended for replacement.

For example, the storage unit 603 can store a database of product information of various types of fishing lines. The fishing line product information database can indicate, for example, the make and model of a compatible fishing reel or the make and model of a compatible spool for each product. Alternatively, the notification unit 623 can be configured to be capable of accessing an external fishing line product information database via a network.

From the fishing line product information database, the notification unit 623 identifies fishing line products recommended as replacements and acquires the identified product information. When the product information is obtained, information regarding the model of the spool on which the fishing line to be inspected is wound and information regarding the model of the corresponding fishing reel 1 included in the reel usage history information can be used.

Such fishing line product information recommended for replacement can be treated as information (information regarding maintenance performance-related matters) regarding the performance of fishing tackle maintenance work for the replacement of fishing line. In the Step S208, a URL for a video or an instruction manual describing how to replace fishing line, or the like, can be obtained as information regarding maintenance performance-related matters other than the fishing line product information. Furthermore, a link (URL) to an EC (Electronic Commerce) site where the fishing line that is recommended for replacement can be purchased can be obtained.

Step S210: The notification unit 623 generates a maintenance screen that reflects the content of the determination result of Step S204. Further, once the procedure from Step S208 through Step S210 has been followed, the notification unit 623 generates a maintenance screen that reflects, in addition to the content of the determination result of Step S204, information regarding maintenance performance-related matters, such as the URLs and product information regarding the fishing line that was acquired in Step S208.

If the maintenance screen includes a link to an EC site where fishing line can be purchased, the user clicks on the link, and the user terminal 500 accesses the web page of the EC site where the target fishing line is sold. The user can purchase the fishing line on the EC site.

Step S212: The notification unit 623 transmits the maintenance screen generated in Step S210 to the user terminal 500 of the access source.

In the present embodiment, the inspection matters are not limited to the deterioration of fishing line wound on the spool 3 of the fishing reel 1.

Inspection matters regarding the fishing reel 1 other than the deterioration of fishing line wound on the spool 3 can include the quantity of fishing line wound on the spool 3, as described above. Further, inspection matters regarding the fishing reel 1 can include scratches on the fishing reel or distortion of the fishing reel.

For example, when distortion of the fishing reel is a matter for inspection, the user uses the camera 505 of the user terminal 500 and performs an operation to capture images of the fishing reel 1 from several angles. In response to such an image capture operation, the user terminal 500 acquires a plurality of captured images of the fishing reel 1 taken from several different directions. The user terminal 500 transmits an inspection request that includes the plurality of acquired captured images and that specifies distortion in the fishing reel as the matter for inspection to the maintenance support server 600. At this time, the user terminal 500 can also include the reel usage history information acquired from the fishing reel 1 in the inspection request.

The identification unit 621 of the maintenance support server 600 identifies the fishing reel 1 from the captured images in response to receiving the inspection request. In this case, the identification unit 621 can identify the manufacturer, model, etc., of the fishing reel 1.

In this case, for example, when determining distortion of the fishing reel 1, the determination unit 622 can compare the three-dimensional shape of the fishing reel 1 derived from the images of the identified fishing reel 1 and model data of the three-dimensional shape of the fishing reel 1 provided from the manufacturer, or the like.

In accordance with such a process, the storage unit 603 can store the model data of the three-dimensional shape of the fishing reels for each manufacturer/model, and the determination unit 622 can acquire the model data from the storage unit 603. Alternatively, the storage unit 603 can acquire the model data from an external model data database via communication.

Alternatively, the determination unit 622 can use a learned model that has been trained to output determination results regarding distortion in response to an input image of the fishing reel to make a determination regarding distortion of the fishing reel.

The determination unit 622 can determine the presence or absence of distorted parts of the reel as a determination regarding the distortion of the fishing reel. Further, if it is determined that there is a distorted part, the determination unit 622 can determine whether replacement of the part corresponding to the distorted part is required based on the extent of distortion.

If it is determined that a part needs to be replaced, the notification unit 623 can obtain the product information of the part to be replaced from a product database. Further, when a request regarding the replacement of a part is made to the manufacturer, the cost (repair cost) to replace the part can be acquired. Repair costs can be associated with products and stored in the product database. Further, if the user can replace the part himself or herself, the notification unit 623 can acquire a URL for a video or an instruction manual explaining the replacement procedure of the corresponding part.

The notification unit 623 causes the user terminal 500 to display a maintenance screen that reflects the information obtained as described above.

In the present embodiment, as described above, besides fishing reels, fishing rods can also be a matter for inspection. Examples of fishing rod inspection-related matters include scratches on the fishing rod body, distortion of the fishing rod body, matters regarding parts of the fishing rod body (for example, scratches on the fishing line guides or distortion of the fishing line guides, scratches on the reel seat or distortion of the reel seat, and the like).

As a specific example, when a fishing line guide is to be inspected for scratches, distortion, etc., the user uses the camera 505 of the user terminal 500 to capture an image of the fishing line guide to be inspected from among the fishing line guides provided on the fishing rod 400. At this time, the user can capture images of the fishing line guide to be inspected from several different angles.

In response to such an image capture operation, the user terminal 500 acquires the captured images of the fishing line guide to be inspected. The user terminal 500 transmits an inspection request that includes the plurality of acquired captured images and that specifies scratches or distortion of the fishing line guide as the matter for inspection to the maintenance support server 600.

The identification unit 621 of the maintenance support server 600 identifies the fishing line guide to be inspected from the captured image in response to receiving the inspection request. The determination unit 622 makes a determination regarding scratches or distortion of the identified fishing line guide.

The determination unit 622 can determine the presence or absence of portions of the fishing line guide with scratches or distortion as a determination regarding scratches or distortion of the fishing line guide. If it is determined that there is a distorted part, the determination unit 622 also determines whether replacement of the fishing line guide is required based on the extent of the damage or distortion.

If it is determined that the part must be replaced, the notification unit 623 can acquire the product information of the fishing line guide to be replaced from a product database. Further, when a request regarding the replacement of the fishing line guide is made to the manufacturer, the cost (repair cost) of the replacement can be acquired. Further, if the user can replace the fishing line guide himself or herself, the notification unit 623 can acquire a URL for a video or an instruction manual explaining the replacement procedure of the corresponding the fishing line guide.

The notification unit 623 causes the user terminal 500 to display the maintenance screen that reflects the information obtained as described above.

### Second Embodiment

The fishing tackle maintenance support system of the first embodiment described above is configured to inspect fishing tackle based on captured images. In the second embodiment, the fishing tackle maintenance support system inspects fishing tackle based on sounds emitted from the fishing tackle.

Taking a fishing reel as an example, there are cases in which internal parts of the fishing reel can emit unusual sounds that differ from normal sounds due to the wear and tear of internal gears or other parts. When the fishing reel is an electric reel, an abnormal motor or motor circuit, etc., can also emit motor rotation sounds that differ from normal sounds. In consideration of such circumstances, it is effective to inspect the fishing reel based on the sounds emitted by the fishing reel.

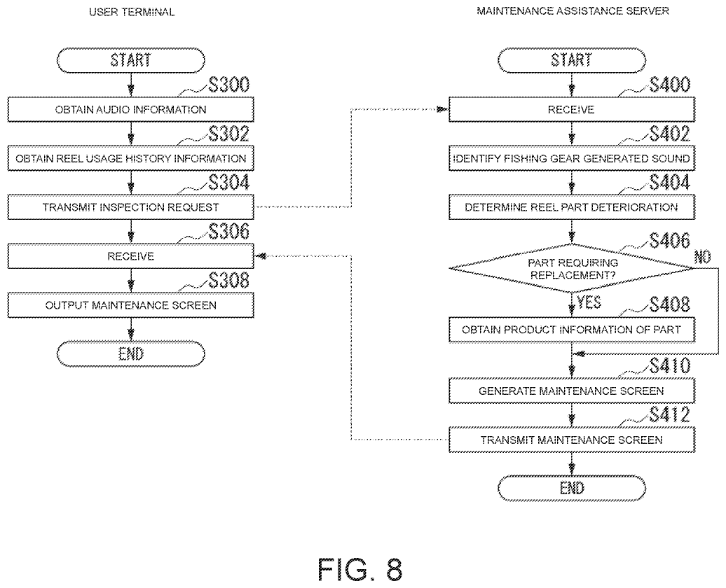

Referring to the flowchart of FIG. 8, an example of a processing procedure executed by the maintenance support server 600 and the user terminal 500 of the present embodiment regarding the inspection of fishing tackle will be described. The case in which the fishing tackle to be inspected is a fishing reel 1 is used as an example in the explanation of the above-mentioned figure.

An example of a processing procedure executed by the user terminal 500 will be described first.

Step S300: The user performs an operation to rotate the spool 3 of the fishing reel 1 using the motor 4. The fishing reel 1 in this case can be capable of setting an inspection mode in accordance with the user's operation. In the inspection mode, the fishing reel 1 can be configured to be able to carry out an operation to rotate the spool 3 by driving of the motor 4 in response to the turning off of the clutch mechanism, for example. As a result, because the spool 3 can be prevented from rotating even if the motor 4 is being driven, it is possible to prevent the tackle from becoming caught.

Alternatively, because inspection of the tackle, etc., is prioritized, if the sound of the motor 4 being driven is not necessary, the user can operate the handle 20 to rotate the spool 3. Further, if the user wishes to inspect a part associated with the clutch mechanism, the user can operate the clutch operating member 50 to turn the clutch mechanism on and off.

In a state in which the spool 3 is rotated or the clutch mechanism is turned on/off, as described above, the user operates the user terminal 500 to record sounds emitted from the fishing reel 1. The user terminal 500 can record an audio signal collected by the microphone 506 by a sound recording function. Alternatively, the user terminal 500 can record the audio signal collected by the microphone 506 together with captured images by a video recording function. The control unit 508 of the user terminal 500 acquires data (audio information) of the audio signal obtained by sound recording, as described above.

Step S302: In the present embodiment as well, the reel usage history information can be used for the inspection. Thus, the control unit 508 causes the communication unit 501 to be communicatively connected to the fishing reel 1. The control unit 508 acquires the reel usage history information stored by the communicatively connected fishing reel 1.

Step S304: The control unit 508 causes the maintenance support server 600 to access the user terminal 500 via a network. The control unit 508 transmits, to the maintenance support server 600 via a network, an inspection request that includes the audio information acquired in Step S300 and the reel usage history information acquired in Step S302 and that instructs an inspection regarding the fishing reel 1.

In the case that audio information is obtained together with captured images by means of video recording, the inspection request can include video recording information including captured images and audio information.

Step S306: The control unit 508 receives a maintenance screen transmitted from the maintenance support server 600 in response to the inspection request transmitted in Step S304.

Step S308: The control unit 508 causes the display unit 503 to output the maintenance screen received in Step S306. Further, if voice is added to the maintenance screen, the control unit 508 can output the added voice to the sound output unit 504.

An example of a processing procedure executed by the maintenance support server 600 will be now described.

Step S400: In the maintenance support server 600, the identification unit 621 receives the inspection request transmitted from the user terminal 500 in Step S304.

Step S402: The identification unit 621 identifies the sound (fishing tackle generated sound) emitted from the fishing reel 1 from the audio signal included in the inspection request received in Step S400.

When video recording information including captured images and audio information is included in the inspection request, the identification unit 621 can be configured to be capable of identifying the manufacturer, model, etc., of the fishing reel 1 based on the image of the fishing reel 1 included in the captured images.

Step S404: The determination unit 622 makes a determination regarding the deterioration of a part of the fishing reel 1 based on the fishing tackle generated sound identified in Step S402. When making such a determination, the determination unit 622 can use a learned model that has been trained to determine which part of the fishing reel has deteriorated and to what degree, in accordance with the input of the fishing tackle generated sound.

Step S406: In this case, the determination unit 622 determines whether a determination result regarding determining the deterioration of the part in Step S404 that indicates that there is a part that must be replaced was obtained.

Step S408: If a determination result indicating that it is necessary to replace the fishing line was obtained, the notification unit 623 acquires the product information of the part to be replaced from a product information database. The product information of the part can also be treated as information (information regarding maintenance performance-related matters) regarding the performance of the fishing tackle maintenance work for the replacement of parts.

In the Step S408, besides the product information regarding the fishing line, the cost of requesting the manufacturer to replace the part, the URL of a video explaining how to replace the part, or an exploded view of the fishing reel can be acquired as maintenance performance-related information.

Step S410: The notification unit 623 generates a maintenance screen that reflects the contents of the determination result of Step S404. Further, once the procedure from Step S408 through Step S410 has been followed, the notification unit 623 generates a maintenance screen that reflects, in addition to the contents of the determination result of Step S404, information regarding maintenance performance-related matters such as product information associated with the part to be replaced acquired in Step S408.

Further, if the determination unit 622 determines that, although the replacement of a part is not necessary, maintenance work, such as the injection of oil or grease, should be performed, the notification unit 623 can issue a notification prompting the user to execute the maintenance work of injecting the oil or grease at an early date. At this time, product information regarding oil or grease products, URLs of videos explaining how to inject the oil or grease, or the like, can be reported.

Step S412: The notification unit 623 transmits the maintenance screen generated in Step S410 to the accessing user terminal 500.

An inspection based on captured images of the first embodiment and an inspection based on sounds emitted from the fishing tackle of the present embodiment can be used in combination. In this case, inspection can be carried out with respect to one inspection target using both captured images and sound emitted from the fishing tackle, or an inspection based on captured images can be carried out for one inspection target while an inspection based on emitted sounds can be carried out with respect to another inspection target.

Modified examples of each of the embodiments described above will be described below.

### First Modified Example

In each of the embodiments described above, the fishing-related support server 600 is communicatively connected to the user terminal 500 via a network. However, it is anticipated that network connections may not be available at the fishing trip locations. In particular, it may be difficult to connect to a network when fishing offshore by boat or on a rocky shore far from the coast.

Thus, for example, a device (fishing-related support device) corresponding to the fishing-related support server 600 of the embodiments described above can be provided on the boat, at a managed fishing spot, a facility near a fishing spot, or the like, and the fishing-related support device and the user terminal 500 can be configured to be connected to each other by WI-FI (registered trademark), BLUETOOTH (registered trademark), or the like. Alternatively, the functions of the fishing-related support server 600 of the above-described embodiments can be shared between the fishing-related support device and the user terminal 500. In this case, the functions to be provided to the user terminal 500 can be downloaded and implemented on the user terminal 500 in advance.

### Second Modified Example

In each of the embodiments of the fishing tackle maintenance support system described above, the fishing reel 1 to be inspected is an electric reel. However, the fishing reel to be inspected is not limited to an electric reel. For example, the fishing reel to be inspected can be a dual-bearing reel (bait reel) or a spinning reel.

In the first embodiment, when a fishing reel such as a dual-bearing reel or a spinning reel 1 is to be inspected, the user can operate the user terminal 500 to capture images from several different angles of the fishing reel or the fishing line wound on the spool.

Further, in the second embodiment, when a fishing reel such as a dual-bearing reel or a spinning reel is to be inspected, the user can cause the user terminal 500 to make a sound recording or video recording and cause the user terminal 500 to acquire audio information in a state in which the handle, etc., is operated to rotate the spool.

In this embodiment as well, if the fishing reel such as a dual-bearing reel or a spinning reel is configured to be capable of storing reel usage history information, the user terminal 500 can acquire the reel usage history information from the fishing reel and transmit an inspection request that includes the captured images or audio information and the reel usage history information to the maintenance support server 600.

The maintenance support server 600 is configured to carry out a determination regarding the inspection described in each of the embodiment described above, in accordance with the inspection request transmitted from the user terminal 500, and to issue a notification of the determination result to the user terminal 500.

Further, in a dual-bearing reel that is capable of braking control for preventing backlash at the time of casting, the identification unit 621 of the maintenance support server 600 can identify a sound associated with the braking control that takes place during casting. The determination unit 622 can determine the deterioration of parts regarding the braking control based on the identified braking control sounds. Further, the determination unit 622 can determine the suitability of the parameter settings of the braking control based on the identified braking control sounds.

Further, when the inspection target is a spinning reel, an inspection regarding the winding of fishing line on a spool can be possible by the first embodiment.

As one inspection matter regarding the winding of fishing line on a spool, it can be possible to determine the amount of backing line on the spool. In this case, the user operates the user terminal 500 to capture an image of a spool around which no fishing line or backing line is wound. At this time, the user preferably captures an image of the spool from the side after removing the spool from the spinning reel.

Further, the user operates the user terminal 500 to input the spool size, the type, diameter (gauge), length, etc., of the fishing line to be wound on the spool, as information (backing line determination use information) used for the determination of the backing line amount.

The user terminal 500 transmits an inspection request including the captured images obtained by imaging the spool and the input backing line determination use information to the maintenance support server 600.

The maintenance support server 600 determines the amount of backing line based on the captured images and the backing line determination use information included in the received inspection request and causes the user terminal 500 to display a maintenance screen notifying the user of the determined amount of backing line. In this case, the maintenance screen can show the determined amount of backing line in a prescribed manner with respect to the photographed spool, for example.

As another inspection matter regarding the winding of fishing line on a spool, it can be possible to determine the appropriate adjustment of an adjustment washer (washer) for eliminating vertical bias of the fishing line wound on the spool.

In this case, the user operates the user terminal 500 to capture images of a spool around which fishing line is wound. At this time as well, the user preferably captures an image of the spool from the side after removing the spool from the spinning reel.

The user terminal 500 transmits an inspection request to the maintenance support server 600 that includes the captured images obtained by photographing the spool and that instructs the server to make a determination regarding the adjustment details of the adjustment washer.

The maintenance support server 600 determines the adjustment details of the adjustment washer (the number, thickness, etc., of the adjustment washer(s) to be used) which are considered appropriate based on the state of vertical bias of the fishing line wound on the spool in the captured image included in the received inspection request, and causes the user terminal 500 to display the maintenance screen that notifies the user of the determined adjustment details.

### Third Modified Example

The determination unit 622 of the maintenance support server 600 can be configured to be capable of making determinations regarding inspections based on the reel usage history information without the use of captured images or audio information.

### Fourth Modified Example

When the fishing reel is equipped with a display unit, the user terminal 500 can transfer the inspection-related determination result transmitted from the maintenance support server 600 to the fishing reel, thereby causing the inspection-related determination result to be displayed on the fishing reel.

### Fifth Modified Example

At least some of the functions of the maintenance support server 600 can be provided in the user terminal 500.

The above-described processes as the fishing reel 1, the user terminal 500, the maintenance support server 600, etc., can be performed by storing a program for realizing the above-described functions as the fishing reel 1, the user terminal 500, the maintenance support server 600, etc., in a computer-readable storage medium and having a computer system read and execute the program that is stored on the storage medium. Here, “having a computer system read and execute the program that is stored on the storage medium” includes the installation of the program in the computer system. The “computer system” here includes the OS and hardware such as peripheral devices. Further, the “computer system” can also include a plurality of computer devices that are connected via a network, including the Internet and communication lines such as WAN, LAN, and dedicated lines. Further, the “computer-readable storage medium” refers to storage devices such as portable media like flexible discs, magnetooptical discs, ROM, CD-ROM, and HDD, and the like, incorporated in a computer system. In this manner, the storage medium that stores the program can be a non-transitory storage medium, such as a CD-ROM. Further, the storage medium includes an internally or externally provided storage medium that can be accessed from a distribution server in order to distribute the aforementioned program. The program code that is stored on the storage medium of the distribution server can differ from the program code that is in a format that can be executed by the terminal device. That is, as long as the program can be downloaded from the distribution server and installed in a form that can be executed by the terminal device, the format in which the program is stored in the distribution server is not limited. The program can be divided into a plurality of modules and merged on the terminal device after downloading at different times, or the distribution server that distributes each of the divided programs can be different. Moreover, the “computer-readable storage medium” shall also include media that retains the program for a set period of time, such as volatile memory (RAM) in the computer system which acts as the server or the client when the program is transmitted via the network. Further, the above-described program can realize some of the above-described functions. Moreover, it can be a program that can realize the above-described functions by being combined with a program that is already stored on the computer system, i.e., a so-called difference file (difference program).

What is claimed is:

1. A fishing tackle management system, comprising:
an identification unit configured to obtain identification results by identifying fishing tackle from an image;
a determination unit configured to obtain determination results by determining fishing tackle matters based on the identification results of the identification unit; and
a notification unit configured to provide a notification to a user based on the determination results of the determination unit as notification information.

2. The fishing tackle management system according to claim 1, wherein
the determination unit is configured to determine maintenance matters related to the fishing tackle.

3. The fishing tackle management system according to claim 2, wherein
the fishing tackle is a fishing reel, and
the determination unit is configured to determine reel maintenance matters related to the fishing reel.

4. The fishing tackle management system according to claim 3, wherein
the reel maintenance matters include at least one of scratches of the fishing reel, distortion of parts of the fishing reel, fishing line issues of a fishing line wound on a spool, and reel setting state issues of the fishing reel.

5. The fishing tackle management system according to claim 2, wherein
the fishing tackle is a fishing rod, and
the determination unit is configured to determine rod maintenance matters related to fishing rod.

6. The fishing tackle management system according to claim 5, wherein
the rod maintenance matters include at least one of scratches of the fishing rod, distortion of the fishing rod, and rod setting state issues of the fishing rod.

7. The fishing tackle management system according to claim 6, wherein
the rod setting state matters include line guide issues or reel seat issues,
the line guide issues including scratches or distortion of the line guide, and
the reel seat issues including scratches or distortion of the reel seat.

8. The fishing tackle management system according to claim 1, wherein
the identification unit is configured to obtain identification results by identifying fishing tackle from operation sounds of the fishing tackle, and
the determination unit is configured to obtain determination results by determining fishing tackle matters based on the identification results of the identification unit.

9. The fishing tackle management system according to claim 2, wherein
the determination unit is configured to determine maintenance matters related to performance of maintenance work of the fishing tackle.

10. The fishing tackle management system according to claim 9, wherein
the notification unit is configured to provide a user cost information based on maintenance matters determined by the determination unit.

11. A fishing tackle management program for causing a computer to function as the fishing tackle management system according to claim 1.

12. A fishing tackle management system, comprising:
an identification means for obtaining identification results by identifying fishing tackle from an image;
a determination means for obtaining determination results by determining fishing tackle matters based on the identification results of the identification unit; and
a notification means for making a notification to user based on the determination results of the determination unit as notifications information.
